(19) United States
(12) Patent Application Publication
(10) Pub. No.: US 2023/0323988 A1
(43) Pub. Date: Oct. 12, 2023

(54) BALL JOINT PIPE CLAMP WITH RETENTION TAB

(71) Applicant: Norma U.S. Holding LLC, Auburn Hills, MI (US)

(72) Inventors: Chunzhi Jiang, Sterling Hts., MI (US); Heather Keller, Clarkston, MI (US)

(21) Appl. No.: 18/131,415

(22) Filed: Apr. 6, 2023

Related U.S. Application Data
(60) Provisional application No. 63/327,881, filed on Apr. 6, 2022.

(51) Int. Cl. F16L 23/08

(52) U.S. Cl. CPC F16L 23/08

(57) ABSTRACT

A pipe clamp employed in use in ball and flare joints, as well as possibly other types of joints. The pipe clamp has a band and a tightening assembly, among other potential components. The tightening assembly has a bolt and a threaded hardware member. One or more retention tabs serve to prevent unwanted dislocation of the threaded hardware member from its intended location at the band amid a tightening action of the tightening assembly.

### CROSS-REFERENCE TO RELATED APPLICATION

This application claims the benefit of U.S. Provisional Patent Application No. 63/327,881, with a filing date of Apr. 6, 2022, the contents of which are hereby incorporated by reference in their entirety.

### TECHNICAL FIELD

This disclosure relates generally to pipe clamps with spherically-profiled bands and bands of similar profile, and to ball and flare joints and other types of joints established thereby.

### BACKGROUND

Pipe clamps are typically used to join variously configured pipe ends in vehicle exhaust systems, as well as in other applications. One example is a pipe clamp of the type used for a ball and flare joint in which a flared pipe end partially overlaps a balled pipe end when the associated pipe ends are mated together. Due to their configuration, a certain degree of angular misalignment between axes of the pipes may occur, while still suitably connecting the pipe ends. The pipe clamps of this type commonly have bands exhibiting a spherical profile to match the ball-like profile of the balled and flared pipe ends, and commonly have a tightening mechanism that is tightened down in order to establish a fluid-tight joint at the balled and flared pipe ends.

### SUMMARY

In an embodiment, a pipe clamp may include a band, a tightening assembly, and one or more retention tabs. The band has a generally spherical profile between a first axial end and a second axial end. The generally spherical profile is at a main region of the band. The band has a first circumferential end region and a second circumferential end region. A first pocket is established at the first circumferential end region, at the second circumferential end region, or at both the first and second circumferential end regions. The tightening assembly has a bolt, a first trunnion, and a second trunnion. The bolt is received through a first bolt hole residing in the first trunnion, and is received through a second bolt hole residing in the second trunnion. The first trunnion is seated in the first pocket, and the second trunnion is seated in the second pocket. The retention tab(s) extends from the second circumferential end region. The retention tab(s) makes surface-to-surface confrontation, or more (e.g., engagement), with a backside surface of the second trunnion.

In an embodiment, a pipe clamp may include a band, a tightening assembly, and one or more retention tabs. The band has a first circumferential end region and has a second circumferential end region. The tightening assembly brings the first circumferential end region and the second circumferential end region toward each other and away from each other upon the respective performance of tightening and loosening actions of the tightening assembly. The tightening assembly has a bolt and has a threaded hardware member. The bolt is received through the threaded hardware member in assembly. The threaded hardware member is located at the second circumferential end region. The retention tab(s) is situated near the threaded hardware member. The retention tab(s) has an inner surface that makes surface-to-surface confrontation, or more (e.g., engagement), with the threaded hardware member. The retention tab(s) has a free end that is spaced from the band and that is spaced from the second circumferential end region.

In an embodiment, a method of preventing dislocation of tightening assembly hardware upon the occurrence of a tightening action of a tightening assembly in a pipe clamp may include several steps. One step may involve seating a threaded hardware member of the tightening assembly at a circumferential end region of a band. Another step may involve bringing one or more retention tabs in surface-to-surface confrontation, or more (e.g., engagement), with the threaded hardware member. The retention tab(s) has a free end that is spaced from the band. Upon dislodgement of the threaded hardware member from the circumferential end region during the tightening action of the tightening assembly and rundown of a bolt of the tightening assembly, surface-to-surface engagement between the threaded hardware member and the retention tab(s) prevents further dislocation of the threaded hardware member from the circumferential end region.

### BRIEF DESCRIPTION OF THE DRAWINGS

Embodiments of the disclosure are described with reference to the appended drawings, in which:

FIG. 1 is a perspective view of an embodiment of a ball joint pipe clamp;

FIG. 2 is a cross-sectional view of an embodiment of a ball and flare joint established with the ball joint pipe clamp;

FIG. 3 is a front view of the ball joint pipe clamp;

FIG. 4 is a side view of the ball joint pipe clamp; and

FIG. 5 is an enlarged view of an embodiment of retention tabs of the ball joint pipe clamp; and

FIG. 6 is a flow chart of an embodiment of a method of preventing dislocation of hardware amid a tightening action of the ball joint pipe clamp.

### DETAILED DESCRIPTION

With reference to the figures, an embodiment of a ball joint pipe clamp 10, or pipe clamp 10, is presented that is employed in use to establish a fluid-tight ball and flare joint at a pair of pipe ends. The ball joint pipe clamp 10 has a pair of retention tabs that serves to preclude an unwanted dislodgement of a trunnion from a pocket amid a tightening action, which has been found especially precarious in clamps intended for larger-sized applications. When dislodged, the trunnion spins freely on an associated bolt, and without the restraint furnished by the pocket and needed amid the tightening action. This description presents the ball joint pipe clamp 10 in the context of an automotive application (e.g., ball and flare joints of automotive exhaust pipes), but the ball joint pipe clamp 10 has broader application and is suitable for use in aerospace, marine, industrial, construction, and oil and gas applications, as well as others, and could be employed in joints other than ball and flare joints. Moreover, the retention tabs could serve to preclude unwanted dislocation of other tightening hardware other than a trunnion, as set forth below. Furthermore, and unless otherwise specified, the terms radially, axially, and circumferentially, and their grammatical variations, refer to directions with respect to the generally circular shape of the ball joint pipe clamp 10 as illustrated in the figures. In this sense, axially refers to a direction that is generally along or parallel to a central axis of the circular shape, radially refers to a direction that is generally along or parallel to a radius of the circular shape, and circumferentially refers to a direction that is generally along or in a similar direction as a circumference of the circular shape.

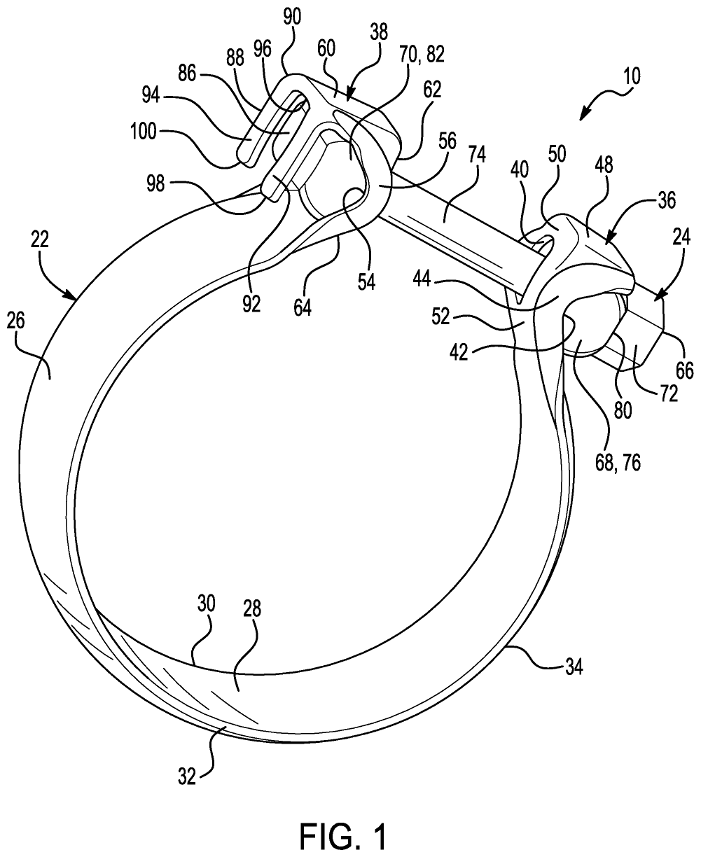

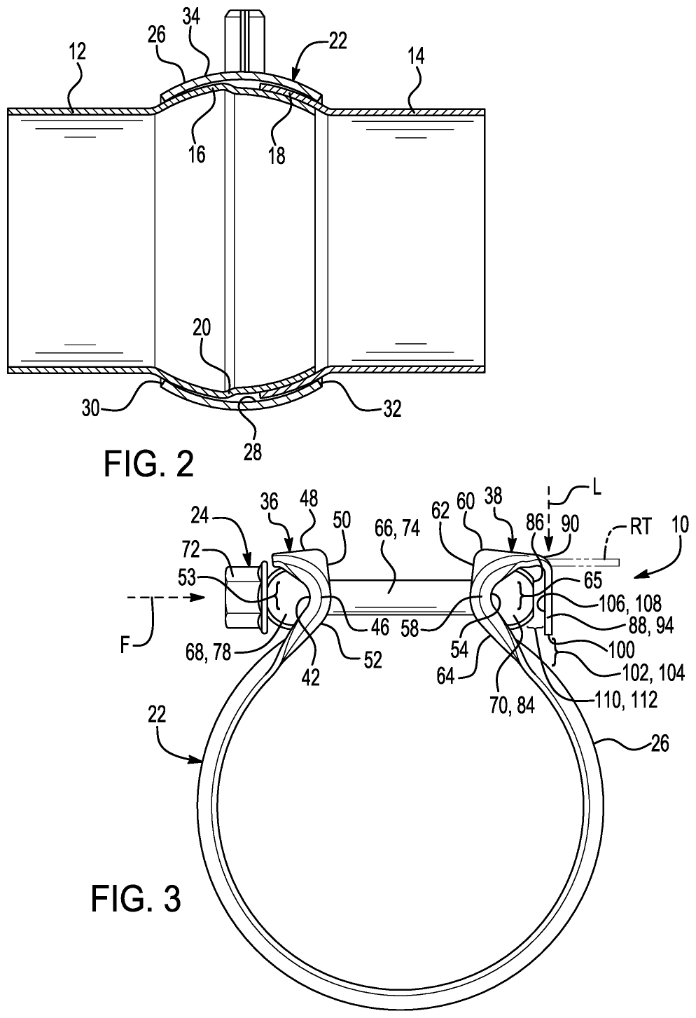

With reference to FIGS. 1 and 2, the ball joint pipe clamp 10 establishes a fluid-tight joint between a pair of overlapping flanged end regions of a first pipe 12 and a second pipe 14. The first and second pipes 12, 14 can be composed of a metal material. The first pipe 12 has a balled pipe end 16, and the second pipe 14 has a flared pipe end 18. The balled and flared pipe ends 16, 18 exhibit somewhat complementary spherical profiles. The balled pipe end 16 and flared pipe end 18 come together in mating arrangement for assembly and installation, as depicted in FIG. 2, with the balled pipe end 16 inserted into the flared pipe end 18. The balled pipe end 16 in this embodiment has a step 20 approximately midway in its structure in order to accommodate placement of the ball joint pipe clamp 10 thereover and establishment of surface-to-surface sealing engagement at interfaces among the ball joint pipe clamp 10 and the balled and flared pipe ends 16, 18. Although shown with axes aligned and coincident in FIG. 2, the first and second pipes 12, 14 can be swiveled relative to each other about the balled and flared pipe ends 16, 18 with their respective axes angularly misaligned in some cases by as much as three degrees (3°) of angular misalignment, while still establishing an effective fluid-tight joint.

The ball joint pipe clamp 10 can have various designs, constructions, and components in different embodiments depending upon—among other potential factors—the overlapping pipe end regions and the precise fastening mechanism equipped in the ball joint pipe clamp. In the embodiment of the figures, the ball joint pipe clamp 10 has a band 22 and a tightening assembly 24.

The band 22 encircles the balled and flared pipe ends 16, 18 when put in place, and is tightened down on the balled and flared pipe ends 16, 18 to exert a clamping force thereon for establishing the intended fluid-tight joint. The band 22 can be composed of a metal material such as stainless steel. With particular reference to FIGS. 1 and 2, the band 22 has an exterior surface 26 on a radially-outboard side, and has an interior surface 28 on a radially-inboard side. The band 22 spans axially between a first axial end 30 and a second axial end 32. The band 22 exhibits a generally spherical and roundish profile between the first axial end 30 and the second axial end 32. The spherical profile is effected at a main body and main region 34 of the band 22. The main region 34 and its spherical profile are sized and shaped somewhat complementary to the spherical profiles of the balled and flared pipe ends 16, 18. Still, the generally spherical band profile need not necessarily exhibit strict sphericality, and rather the band 22 could be partially spherical with non-spherical axial end wall portions according to some embodiments.

The band's main region 34 terminates at opposite ends at a first circumferential end region 36 and at a second circumferential end region 38. The first and second circumferential end regions 36, 38 are unitary extensions of the band 22. While depicted as continuous in the embodiment of the figures, the band's main region 34 could be discontinuous and segmented along its circumferential extent in other embodiments. The first and second circumferential end regions 36, 38 constitute head formations that accommodate installation of the tightening assembly 24. Further, the first and second circumferential end regions 36, 38 interact with the tightening assembly 24 and can carry the tightening assembly 24 before installation, as depicted in FIG. 1. In ordinary circumstances, the first and second circumferential end regions 36, 38 are urged and drawn toward each other upon a tightening action of the tightening assembly 24, and are conversely brought away from each other upon a loosening action of the tightening assembly 24. A bolt hole 40 (only one shown) resides in each of the first and second circumferential end regions 36, 38. The first and second circumferential end regions 36, 38 establish internal cavities and pockets for accepting reception of trunnions (introduced below) of the tightening assembly 24. The pockets can be established in various ways according to different embodiments. In the embodiment of the figures, and with reference to FIGS. 1 and 3, a first pocket 42 is established via the first circumferential end region 36. Here, a first side segment wall 44, a second side segment wall 46, and a top segment wall 48 partly define the first pocket 42. A back segment wall 50 and a bottom segment wall 52 also partly define the first pocket 42. The first pocket 42 remains open at a frontside open end 53 and opposite the back segment wall 50 in order to accept reception of a trunnion (introduced below) of the tightening assembly 24. In a similar way, a second pocket 54 is established via the second circumferential end region 38. Here, a first side segment wall 56, a second side segment wall 58, and a top segment wall 60 partly define the second pocket 54. A back segment wall 62 and a bottom segment wall 64 also partly define the second pocket 54. The second pocket 54 remains open at a frontside open end 65 and opposite the back segment wall 62 in order to accept reception of another trunnion (introduced below) of the tightening assembly 24.

The tightening assembly 24 is employed in use to tighten and loosen the band 22 on and off of the balled and flared pipe ends 16, 18. The tightening assembly 24 can take various forms according to different embodiments. In the embodiment of the figures, and with continued reference to FIGS. 1 and 3, the tightening assembly 24 includes a bolt 66, a first trunnion 68, and a second trunnion 70. Still, in other embodiments, the tightening assembly could have more, less, and/or different components; for example, the tightening assembly could have a single trunnion as a discrete component. The components can be composed of a metal material. The bolt 66 has a head portion 72 and a stem portion 74. The head portion 72 is engaged by a torque gun or another tool in installation and upon a tightening or loosening action of the tightening assembly 24. In assembly, and as shown in the figures, the stem portion 74 is inserted through the bolt holes 40 of the first and second circumferential end regions 36, 38, and is received through bolt holes of the first and second trunnions 68, 70. The stem portion 74 has external threads that mate and engage with internal threads of at least the second trunnion 70 amid the tightening and loosening actions of the tightening assembly 24. In this regard, one or both of the first and second trunnions 68, 70 serve as threaded hardware members of the tightening assembly 24. Other types of threaded hardware members could include nuts, according to other embodiments. The term “trunnion” as used herein is intended to have an expansive meaning that encompasses such threaded hardware members.

The first trunnion 68 is received and seated in the first pocket 42 in installation and assembly. Its seating can be somewhat snug. When seated, the first trunnion 68 can make direct confrontation and abutment with one or more of the following walls: the first side segment wall 44, the second side segment wall 46, the top segment wall 48, the back segment wall 50, and/or the bottom segment wall 52. The first and second side segment walls 44, 46, for example, restrain lateral side-to-side dislocation of the first trunnion 68 when initially set in the first pocket 42 and before insertion of the bolt 66. The first trunnion 68 has a first side surface 76, a second side surface 78, and a backside surface 80. The first and second side surfaces 76, 78 can make surface-to-surface abutment with the first and second side segment walls 44, 46, respectively. And the backside surface 80 makes surface-to-surface abutment with the head portion 72. The bolt hole of the first trunnion 68 can lack threading; the bolt 66 can simply pass-through the first trunnion 68 in installation and assembly.

The second trunnion 70 is received and seated in the second pocket 54 in installation and assembly. Its seating can be somewhat snug. When seated, the second trunnion 70 can make direct confrontation and abutment with one or more of the following walls: the first side segment wall 56, the second side segment wall 58, the top segment wall 60, the back segment wall 62, and/or the bottom segment wall 64. The first and second side segment walls 56, 58, for example, restrain lateral side-to-side dislocation of the second trunnion 70 when initially set in the second pocket 54 and before insertion of the bolt 66. The second trunnion 70 has a first side surface 82, a second side surface 84, and a backside surface 86. The first and second side surfaces 82, 84 can make surface-to-surface abutment with the first and second side segment walls 56, 58, respectively. The bolt hole of the second trunnion 70 can have internal threading for mating engagement and meshing with complementary and counterpart external threading residing on the bolt's stem portion 74.

The ball joint pipe clamp 10, as described thus far, exhibits effective performance in assembly and installation for pipe diameters of certain sizes and dimensions. But shortfalls have been observed for pipe diameters of a larger size and larger dimension. For ball joint pipe clamps with bands possessing a larger size and dimension and intended for assembly and installation on pipes possessing a diameter of approximately seventy-five millimeters (75 mm) and above, including up to and greater than one-hundred-and-fifty-five millimeters (155 mm), it has been found in certain instances that the second trunnion can become dislodged from its seating and from the second pocket amid a rundown and tightening action of the tightening assembly (“approximately” is used here in order to account for certain engineering and manufacturing tolerances). Such larger-sized pipe diameters are not uncommon in automotive exhaust applications, as well as in construction equipment applications, among others. When dislodged and displaced out of the second pocket, the second trunnion spins freely and unrestrained with the bolt, as the bolt is driven to rotate by the torque gun. The second trunnion could also spin off of the bolt altogether. The bolt may not rotate relative to the second trunnion when the second trunnion is unrestrained, which is needed for proper mating engagement and relative meshing between threads of the bolt and of the second trunnion. The dislodgement has been particularly observed to occur when the torque gun is initially engaged with the bolt's head portion. A force F (FIG. 3) is exerted against the bolt. The force F is in-line with a primary axis of the bolt and is hence axial in this regard and is somewhat tangential to the circular shape of the band. Due to increased flexibility of the larger-sized diameter of the band for the larger-sized pipe diameter, the force F causes the band to bend inward, and the first circumferential end region is in turn moved in the general direction of the second circumferential end region. The second trunnion can consequently be pushed forward and dislocated out of the second pocket via the frontside open end of the second pocket. Apart from these rundown circumstances that typically occur at an assembly and manufacturing facility, the dislodgement of the second trunnion from the second pocket could also occur during transport and shipping of the ball joint pipe clamp prior to installation.

A retention tab 88 has been introduced as part of the ball joint pipe clamp 10 in order to resolve the shortfall caused by the force F. The retention tab 88 effectively precludes and prevents dislodgement and displacement of the second trunnion 70 from its seating and from the second pocket 54 during rundown, and possibly at other times when such a need arises. The retention tab 88 keeps the second trunnion 70 substantially seated in the second pocket 54 in order to maintain sufficient restraint to facilitate proper rundown amid tightening. The retention tab 88 can take various forms according to different embodiments. According to the embodiment of the figures, and with reference now to FIGS. 3-5, the retention tab 88 extends from the second circumferential end region 38, and is a unitary extension of the top segment wall 60. The retention tab 88 depends directly and immediately from the top segment wall 60. A single bend 90 adjoins the retention tab 88 and the top segment wall 60. As depicted perhaps best in the view of FIG. 3, the retention tab 88 depends orthogonally from the top segment wall 60 via the bend 90. Relative to the tightening assembly 24, the retention tab 88 straddles the bolt's stem portion 74 and is situated adjacent the second trunnion 70.

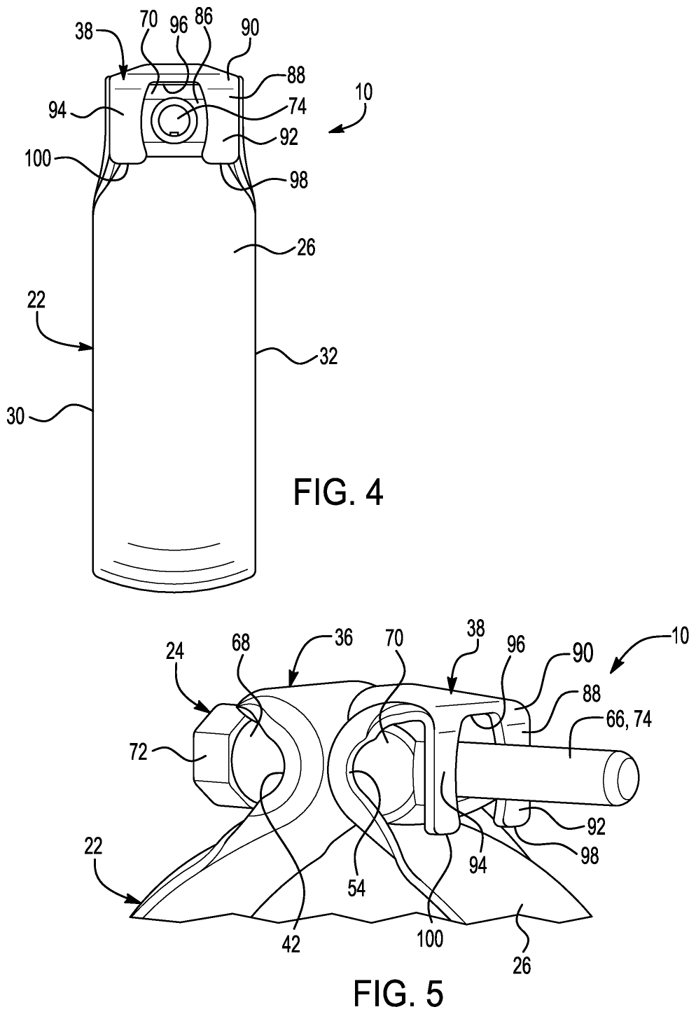

According to this embodiment, the retention tab 88 includes a first retention tab 92, a second retention tab 94, and a recess 96; still, in another embodiment a single retention tab could be provided rather than a pair. The first and second retention tabs 92, 94 are situated on opposite sides of the stem portion 74 in a tightened state, as shown best in FIG. 4, while the recess 96 accommodates reception of the stem portion 74 therebetween. Together, the first and second retention tabs 92, 94 and recess 96 resemble a U-shape. The recess 96 is a void residing between the first and second retention tabs 92, 94. The first and second retention tabs 92, 94 are unidirectional over their full extents from proximal ends adjacent the top segment wall 60 to distal ends, and are co-extensive with respect to each other. At the distal ends, the first retention tab 92 has a first terminal and free end 98, and the second retention tab 94 has a second terminal and free end 100. The first and second terminal ends 98, 100 terminate short of the band 22, and hence the first and second terminal ends 98, 100 remain unattached from the band 22. The first and second retention tabs 92, 94 lack attachment, bonding, welding, and abutment with the band 22. In this sense, the first and second retention tabs 92, 94 exhibit a suspended state adjacent the frontside open end 65 of the second pocket 54 and adjacent the second trunnion 70. Since the band 22 has a general spherical profile according to this embodiment—and is otherwise not flat and planar axial-end-to-axial-end—attachment such as via bonding or welding is more difficult. Introducing bonding or welding, per certain instances, merely adds complexity and expense in the attendant manufacturing process without an appreciable benefit and, in this sense, is superfluous. Further, the first and second terminal ends 98, 100 are unattached relative to each other and spaced laterally apart from each other.

With particular reference now to FIG. 3, a first clearance 102 resides between the first terminal end 98 and the band's exterior surface 26, and a second clearance 104 resides between the second terminal end 100 and the exterior surface 26. The first and second clearances 102, 104 are the result of the first and second terminal ends 98, 100 spaced from the band 22 and remaining unattached from the band 22. Maintaining the first and second clearances 102, 104 have proved beneficial for manufacturing purposes and for production of varying sizes of radii of the band 22 i.e., increasing the radius of the band 22 could cause interference between the band 22 and the first and second retention tabs 92, 94 in the absence of the first and second clearances 102, 104. The first and second clearances 102, 104, per the embodiment here, are established generally in longitudinal direction L (FIG. 3) between the first and second terminal ends 98, 100 and the band 22 and the exterior surface 26. The longitudinal direction L is defined by the lengthwise extents of the first and second retention tabs 92, 94, again per this embodiment. In other embodiments, the first and second clearances 102, 104 could be defined among the first and second terminal ends 98, 100 and another structure or component of the band 22 and/or of the ball joint pipe clamp 10.

Further, at a side directed at the second trunnion 70, the first retention tab 92 has a first inner surface 106 and the second retention tab 94 has a second inner surface 108. At least in the unassembled state, as depicted in FIG. 3 for instance, the first and second inner surfaces 106, 108 confront the second trunnion 70 and, particularly, directly confront the backside surface 86 of the second trunnion 70. The confrontation is across first and second clearances 110, 112 of the respective first and second retention tabs 92, 94. The first and second clearances 110, 112 are defined axially relative to the bolt 66, and reside between the first and second inner surfaces 106, 108 and the backside surface 86 of the second trunnion 70. The first and second clearances 110, 112 span and are maintained over the full longitudinal and lengthwise extents of the first and second retention tabs 92, 94. Still, in other embodiments, the first and second retention tabs 92, 94 could be directed at an angle toward the second trunnion 70 and could make abutment with the second trunnion 70 at the backside surface 86; here, the first and second clearances 110, 112 would be maintained over partial extents of the first and second retention tabs 92, 94.

Manufacture and assembly of the ball joint pipe clamp 10 can involve various processes and steps in different embodiments. Certain steps are described here that are relevant to the first and second retention tabs 92, 94. According to one embodiment, the band 22 can be formed from a blank of sheet metal material. The blank can be subjected to diverse metalworking processes such as stamping, drawing, and cutting procedures in order to form the band's generally spherical and roundish profile, and in order to form the first and second circumferential end regions 36, 38 and the first and second pockets 42, 54; still, other metalworking processes and techniques can be carried out in other embodiments. The first and second retention tabs 92, 94 are made from a portion of the blank spanning and extending from the second circumferential end region 38. Indeed, absent formation of the first and second retention tabs 92, 94, the portion could be discarded as scrap material in some instances. Rather than being discarded, the portion is preserved and employed for useful purposes, particularly for formation of the first and second retention tabs 92, 94. With particular reference to FIG. 3, initially, the portion that will ultimately constitute the first and second retention tabs 92, 94 depends unidirectionally from the top segment wall 60 and without a bend this is represented in FIG. 3 by broken-line shape RT. The portion RT undergoes a bending process in which it is bent downward in FIG. 3 and bent ninety degrees from its previous orientation. Prior to being bent, the second trunnion 70 can first be seated in place within the second pocket 54, and the bolt 66 can be set in place as well and initially threaded with the second trunnion 70; otherwise, the first and second retention tabs 92, 94 could hinder and obstruct such placement. Once bent to their final orthogonal orientation, the first and second retention tabs 92, 94 can trap the second trunnion 70 in the second pocket 54 or at least preclude full dislodgement of the second trunnion 70. The ball joint pipe clamp 10 with the retention tabs 92, 94 bent down and the tightening assembly 24 initially set in place and ready for rundown is depicted in FIGS. 1, 3, and 4, and constitutes a pre-installation state of the ball joint pipe clamp 10. The ball joint pipe clamp 10 can be transported and shipped in the pre-installation state. FIG. 5 depicts a post-installation state of the ball joint pipe clamp 10 in which the first and second circumferential end regions 36, 38 are brought together.

During use, when the force F is exerted and if the second trunnion 70 is pushed forward, the first and second retention tabs 92, 94 arrest complete dislocation and displacement of the second trunnion 70 from the second pocket 54. The first and second inner surfaces 106, 108 can come into surface-to-surface abutment with the backside surface 86 of the second trunnion 70. The abutment arrests further unwanted movement of the second trunnion 70 that may otherwise occur and that could dislodge the second trunnion 70 from the second pocket 54. In this way, the first and second retention tabs 92, 94 keep the second trunnion 70 substantially seated in the second pocket 54 in order to maintain sufficient restraint to facilitate proper rundown of the tightening assembly 24 amid installation. But the first and second retention tabs 92, 94 need not necessarily keep the second trunnion 70 fully seated in the second pocket 54, and rather can maintain the second trunnion 70 in a position relative to the second pocket 54 that effectively restrains the second trunnion 70 for proper rundown.

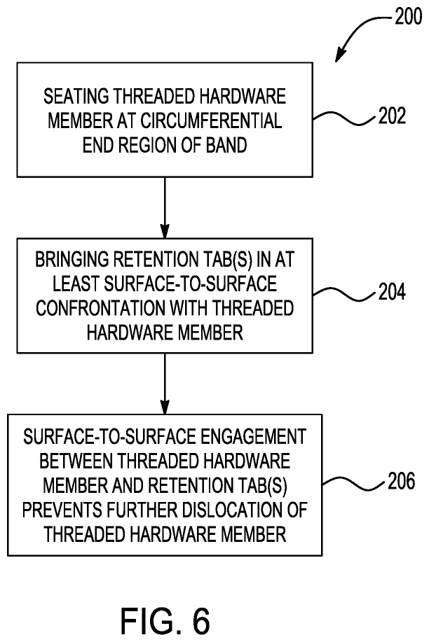

With reference now to FIG. 6, a schematic representation of a method 200 is presented; still, in other embodiments, the method 200 could have more, less, and/or differing steps than those presented here, and the order in which the steps are performed could vary. According to the embodiment of FIG. 6, the method 200 prevents dislocation of hardware members and components of the tightening assembly 24 amid the tightening action of the tightening assembly 24. The hardware members and components can be the second trunnion 70 and/or nuts, as but a couple of examples. The method 200 consists of several steps. A first step 202 involves seating a threaded hardware member at a circumferential end region of a band. An example of the first step 202 can be carried out via seating of the second trunnion 70 in the second pocket 54 of the band 22. A second step 204 of the method 200 involves bringing one or more retention tabs in at least surface-to-surface confrontation with the threaded hardware member. An example of the second step 204 can be carried out via bending the retention tab 88 to bring it into surface-to-surface confrontation with the second trunnion 70. Lastly, a third step 206 of the method 200 involves making surface-to-surface engagement between the threaded hardware member and the retention tab(s) in order to physically block and prevent further dislocation of the threaded hardware member; such engagement can occur upon dislodgement of the threaded hardware member from its seating during the tightening action of the tightening assembly. An example of the third step 206 can be carried out via making surface-to-surface engagement between the second trunnion 70 and the retention tab 88 in order to prevent further dislocation of the second trunnion 70 from the second pocket 54. Sufficient restraint is hence maintained to facilitate proper rundown of the tightening assembly 24 amid installation.

As used herein, the terms “general” and “generally” and “approximately” are intended to account for the inherent degree of variance and imprecision that is often attributed to, and often accompanies, any design and manufacturing process, including engineering tolerances—and without deviation from the relevant functionality and outcome—such that mathematical precision and exactitude is not implied and, in some instances, is not possible. In other instances, the terms “general” and “generally” and “approximately” are intended to represent the inherent degree of uncertainty that is often attributed to any quantitative comparison, value, and measurement calculation, or other representation.

It is to be understood that the foregoing description is not a definition of the invention, but is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” and “such as,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

1. A pipe clamp, comprising:
a band having a generally spherical profile between a first axial end and second axial end at a main region of said band, said band having a first circumferential end region and a second circumferential end region, a first pocket established at said first circumferential end region, and a second pocket established at said second circumferential end region;
a tightening assembly having a bolt, a first trunnion, and a second trunnion, said bolt received through a first bolt hole in said first trunnion and received through a second bolt hole in said second trunnion, said first trunnion seated in said first pocket, and said second trunnion seated in said second pocket; and
at least one retention tab extending from said second circumferential end region and at least making surface-to-surface confrontation with a backside surface of said second trunnion.

2. The pipe clamp as set forth in claim 1, wherein, upon a tightening action of said tightening assembly and rundown of said bolt, surface-to-surface abutment is establishable between said backside surface of said second trunnion and an inner surface of said at least one retention tab in order to prevent dislocation of said second trunnion from said second pocket amid the tightening action of said tightening assembly and rundown of said bolt.

3. The pipe clamp as set forth in claim 1, wherein said at least one retention tab has a terminal end that remains unattached from said band as said at least one retention tab makes surface-to-surface confrontation with said backside surface of said second trunnion.

4. The pipe clamp as set forth in claim 1, wherein said at least one retention tab has a terminal end that is spaced from said band with a clearance residing between said terminal end and said band.

5. The pipe clamp as set forth in claim 1, further comprising a clearance residing between an inner surface of said at least one retention tab and said backside surface of said second trunnion, said clearance maintained over full extents of said inner surface and of said backside surface.

6. The pipe clamp as set forth in claim 1, wherein said at least one retention tab includes a first retention tab and a second retention tab, said first retention tab situated at one lateral side of a stem portion of said bolt and said second retention tab situated at an opposite lateral side of said stem portion.

7. The pipe clamp as set forth in claim 1, wherein said at least one retention tab includes a first retention tab and a second retention tab, a recess residing between said first retention tab and said second retention tab, said recess accommodating reception of said bolt when said tightening assembly is tightened.

8. The pipe clamp as set forth in claim 1, wherein said second circumferential end region includes a first side segment wall, a second side segment wall, and a top segment wall, said first and second side segment walls and top segment wall establishing said second pocket, said at least one retention tab extending from said top segment wall.

9. The pipe clamp as set forth in claim 1, wherein said band has a diameter that is greater than or equal to approximately 75 millimeters (mm).

10. The pipe clamp as set forth in claim 1, wherein said at least one retention tab depends orthogonally from a top segment wall of said second circumferential end region.

11. The pipe clamp as set forth in claim 1, wherein said at least one retention tab extends from said second circumferential end region at a location where said at least one retention tab is suspended adjacent a frontside open end of said second pocket.

12. A pipe clamp, comprising:
a band having a first circumferential end region and a second circumferential end region;
a tightening assembly for bringing said first circumferential end region and said second circumferential end region toward and away from each other amid tightening and loosening actions of said tightening assembly, said tightening assembly having a bolt and a threaded hardware member, said bolt is received through said threaded hardware member in assembly, said threaded hardware member located at said second circumferential end region; and
at least one retention tab situated adjacent said threaded hardware member, said at least one retention tab having an inner surface that at least makes surface-to-surface confrontation with said threaded hardware member, said at least one retention tab terminating at a free end that is spaced from said band and spaced from said second circumferential end region.

13. The pipe clamp as set forth in claim 12, wherein said free end is unattached from said band and exhibits a suspended state adjacent said second circumferential end region.

14. The pipe clamp as set forth in claim 13, further comprising a clearance residing between said free end of said at least one retention tab and said band, said clearance established between said free end and said band in a longitudinal direction defined by a lengthwise extent of said at least one retention tab.

15. The pipe clamp as set forth in claim 14, wherein said at least one retention tab includes a first retention tab and a second retention tab, a recess residing between said first retention tab and said second retention tab, said recess accommodating reception of said bolt, said clearance is a first clearance and a second clearance, said first clearance residing between a first free end of said first retention tab and said band, and said second clearance residing between a second free end of said second retention tab and said band.

16. The pipe clamp as set forth in claim 15, wherein said second circumferential end region includes a first side segment wall, a second side segment wall, and a top segment wall, a pocket established via said first and second side segment walls and said top segment wall, said threaded hardware member seated in said pocket, said first and second retention tabs extending from said top segment wall.

17. A method of preventing dislocation of tightening assembly hardware upon a tightening action of a tightening assembly in a pipe clamp, the method comprising:
seating a threaded hardware member of said tightening assembly at a circumferential end region of a band;
bringing at least one retention tab in at least surface-to-surface confrontation with said threaded hardware member, said at least one retention tab terminating at a free end that is spaced from said band; and
wherein, upon dislodgement of said threaded hardware member from said circumferential end region amid the tightening action of said tightening assembly and rundown of a bolt of said tightening assembly, surface-to-surface engagement between said threaded hardware member and said at least one retention tab prevents further dislocation of said threaded hardware member from said circumferential end region.

18. The method as set forth in claim 17, wherein bringing said at least one retention tab in the at least surface-to-surface confrontation with said threaded hardware member involves bending said at least one retention tab to the at least surface-to-surface confrontation with said threaded hardware member, the bending being carried out after said threaded hardware member is seated in said circumferential end region.

19. The method as set forth in claim 17, further comprising maintaining a clearance between said free end of said at least one retention tab and said band amid the bringing of said at least one retention tab in the at least surface-to-surface confrontation with said threaded hardware member.
